(19) United States
(12) Patent Application Publication
(10) Pub. No.: US 2018/0093673 A1
(43) Pub. Date: Apr. 5, 2018

(54) UTTERANCE DEVICE AND COMMUNICATION DEVICE

(71) Applicant: HONDA MOTOR CO., LTD., Tokyo (JP)

(72) Inventors: Hiromitsu Yuhara, Wako-shi (JP); Tomoko Shintani, Wako-shi (JP); Eisuke Soma, Wako-shi (JP); Shinichiro Goto, Wako-shi (JP)

(73) Assignee: HONDA MOTOR CO., LTD., Tokyo (JP)

(21) Appl. No.: 15/720,177

(22) Filed: Sep. 29, 2017

(30) Foreign Application Priority Data
Sep. 30, 2016 (JP) 2016-195098

(51) Int. Cl. B60W 50/00; G06F 3/16; G06K 9/00; B60W 50/10

(52) U.S. Cl. CPC B60W 50/0098; G06F 3/165; G06F 3/167; B60W 50/10; G06K 9/00832

(57) ABSTRACT

An information acquiring portion acquires at least one of the user information, the in-vehicle condition information, and the traffic condition information of the vehicle. An approach necessity determining portion determines the necessity of the approaches to users based on a first information which is the acquired information. An approach content setting portion determines the contents of the approaches to the users. An approach acceptability estimating portion estimates the acceptability of the user to the communication based on a second information which is the acquired information. If the approach acceptability estimating portion estimates the necessity of the approaches, and the acceptability is larger than a threshold value, an approach implementing portion implements the approaches to the user according to the contents determined by the approach content setting portion.

### CROSS REFERENCES TO RELATED APPLICATIONS

The present application claims priority under 35 U.S.C. §119 to Japanese Patent Application No. 2016-195098, filed Sep. 30, 2016, entitled “Utterance Device and Communication Device.” The contents of this application are incorporated herein by reference in their entirety.

### TECHNICAL FIELD

The present disclosure relates to a device which implements communication between vehicle and passenger.

### BACKGROUND

At the time of going out or traveling by a vehicle, there is a possibility to be caught in traffic congestion. The repetitions including low speed traveling or intermittent stop-and-go driving spoil the pleasure of driving. In such a case, passengers recreationally listen to music and the like through a radio. Manipulating the radio is up to the passengers, mainly to a driver. As mentioned above, in the case that the passenger feels that the pleasure of driving is spoiled, if the vehicle takes some spontaneous actions to the passengers, especially to the driver so as not to be an inorganic machine, it is expected that the driver feels the affinity with the vehicle and somehow solves the dissatisfaction with the feeling that the pleasure is spoiled.

With reference to Japanese Laid-open Patent Publication No. 2005-100382, there is a proposal in which a vehicle-mounted interaction device facilitates users to find new knowledge while listening to an interaction of the characters which are displayed on the display, and moreover, the users themselves are allowed to interact with the characters.

Specifically, based on the detection results of the vehicle condition such as the vehicle speed, or a direction indicator, a scenario containing the interaction between the user avatar and the agent is determined. According to the determined scenario, the user avatar and the agent are displayed, and the interaction between the two is voice output. One of scenario data is selected from a plurality of scenario data. Corresponding to the selected scenario data, the interaction between the user avatar and the agent is controlled. If the information exists in the selected scenario data so as to receive the input from the user at the time when the condition of the vehicle changes, the progress of the interaction is stopped during the predetermined time.

### SUMMARY

However, only considering the vehicle condition leads to a high possibility to advance the interaction between the user avatar and agent while an inappropriate scenario has been selected in the light of the user's feeling and the like, and moreover to urge the user to make the input which means utterance. It is preferable to provide a device in which the vehicle gains the functions to approach the passengers through conversation and the like so as to make the passengers sense the anthropomorphic behavior or the emotional expressions, which allows the passengers to stay somehow comfortable in the vehicle.

One aspect of an utterance device in the present disclosure utters at least to passengers of a vehicle inside the vehicle and has : a passenger information acquiring portion acquiring the information of the passengers including a driver and at least one of the fellow passengers when the utterance device determines whether the number of the passengers is plural or not, and recognizes the existence of the plurality of passengers; an utterance information estimating portion estimating whether the passengers are acceptable for the utterance by the utterance device, or not; and an utterance adjustment directing portion directing the adjustment of the utterance and even if the utterance acceptability estimating portion estimates that one of the passenger is acceptable for the utterance and the other passengers except the one are non-acceptable for the utterance, the utterance adjustment directing portion directs so as to turn down the volume furthermore than the voice level at which the other passengers are presumably acceptable for the utterance. Accordingly, it is possible to make an impression as if the utterance device talks in a low voice by turning down the volume of the utterance, which can gain stage effects as if the device pays attention to the passengers who are presumably non-acceptable for the utterance.

In the utterance device, the utterance adjustment directing portion can direct to adjust the voice localization, it is preferable that the utterance adjustment directing portion directs the adjustment of the voice localization so as to be positioned further away from the other passengers than the voice localization at the time when the other passengers are presumably acceptable for the utterance. Accordingly, it is possible to make an impression as if the conversation is remotely implemented, which can gain stage effects as if the device pays attention to the passengers who are presumably non-acceptable for the utterance.

In one aspect of the communication device according to the present disclosure, the communication device implements the approaches including the utterance to the passengers in the vehicle, is characterized in that the communication device has a passenger information acquiring portion acquiring the information of the passengers during riding; a condition information acquiring portion acquiring at least one of the information among the information of the vehicle, the position information, and the traffic condition information as a condition information; a content setting portion setting the contents of the approaches to the passenger, based on the condition information; an approach acceptability estimating portion which estimates whether the passengers are acceptable for the determined approaches, based on the passenger information, and if it is estimated that the passengers are acceptable for the determined approaches, the communication device implements the approaches, in addition to the utterance based on the passenger information. Accordingly, it is possible to let the passenger know that the approach corresponds to the passengers by uttering so as to correspond to the passengers at the time in addition to the setting of the content of the approaches depending on the condition, which can gain stage effects as if the device pays attention to the passengers.

In the communication device, the communication device has a storage portion which stores the specific information regarding the positioning and simultaneously, stores the history of the approaches implemented. The communication device also has approach content setting portion. In the case that the approach content setting portion sets to present the specific information to the passenger as the content of the approach, it acquires the required specific information by using the position information of the vehicle and extracts the acquired information as a choice for approaching. Meanwhile, if the storage portion has a history presenting the same information, it is preferable that the approach content setting portion sets to exclude the extracted information from the choices. Accordingly, it is possible to avoid repeating the same process, which allows the passengers to feel less disgusted.

In the communication device, the vehicle also has a clocking portion and an audio device, the vehicle information includes the operation time information of the audio device, the condition information includes the timer information, it is preferable that at least any one of the approach acceptability estimating portion and the content setting portion control the process by taking the operation time information into consideration. Accordingly, the condition can be grasped in detail, which makes the acceptability estimation more precise or makes the content setting more preferable.

### BRIEF DESCRIPTION OF THE DRAWINGS

FIG. 1 is an explanatory configuration diagram of the basic system of one embodiment.

FIG. 2 is an explanatory configuration diagram of the agent device.

FIG. 3 is an explanatory configuration diagram of the portable terminal device.

FIG. 4 is an explanatory configuration diagram of the utterance device as one of the embodiment in the present disclosure.

FIG. 5 is an explanatory function diagram of the utterance device.

FIG. 6 is an explanatory diagram regarding the existing Plutchik model.

### DETAILED DESCRIPTION

The Configuration of the Basic System

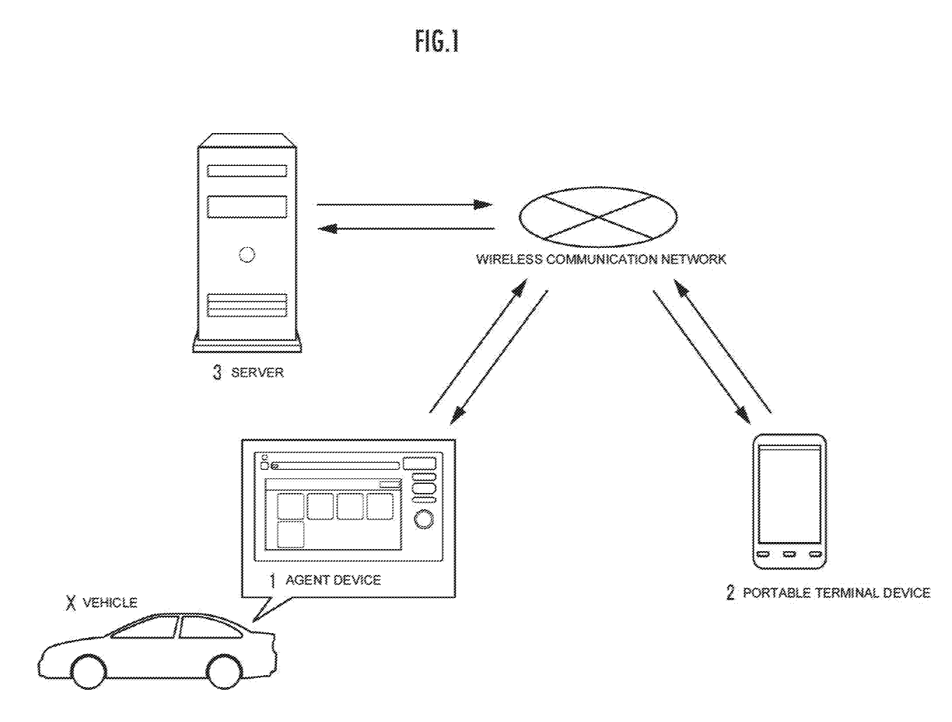

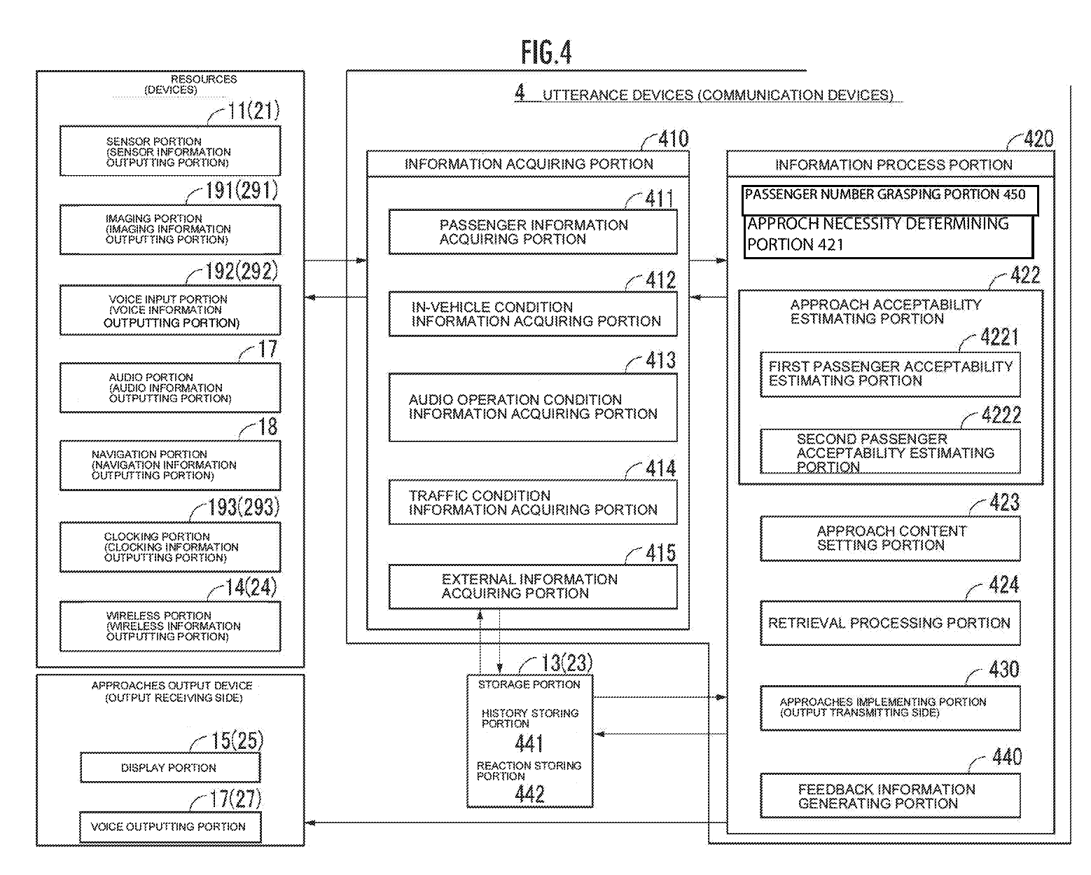

With reference to FIG. 4, an utterance device 4 as one of the embodiment in the present disclosure is configured with at least one part of components of a basic system shown in FIG. 1. The basic system is configured with an agent device 1 mounted on a vehicle X which means a movable body, a portable terminal device 2 such as smartphone which is capable of being carried into the vehicle X by the passengers, and a server 3. The agent device 1, the portable terminal device 2, and the server 3 have a function so as to wireless communicate through a wireless communication network including the internet each other. If the agent device 1 and the portable terminal device 2 are physically close by coexisting in the same space of the vehicle X and so on, the agent device and the portable terminal device have the mutual wireless communication function in a proximity wireless format such as Bluetooth. Bluetooth is a registered trademark.

The agent device 1 shows some reactions to passengers (or users) in the vehicle X, corresponding to the thought, the actions, and the conditions of the passengers. Namely, the agent device is the device which “directly or indirectly approaches”. For example, the agent device 1 can control the vehicle X by taking the passenger' s intention into consideration, can become a conversation partner by some means including the utterance when only the single driver is on the vehicle, and can join the conversation by some means, by providing some topics to keep the pleasant conversation atmosphere between the passengers when there are the plural fellow passengers in the vehicle, and so on. Accordingly, the agent device is the device to assist the passengers to be more comfortable in the vehicle.

The Configuration of the Agent Device

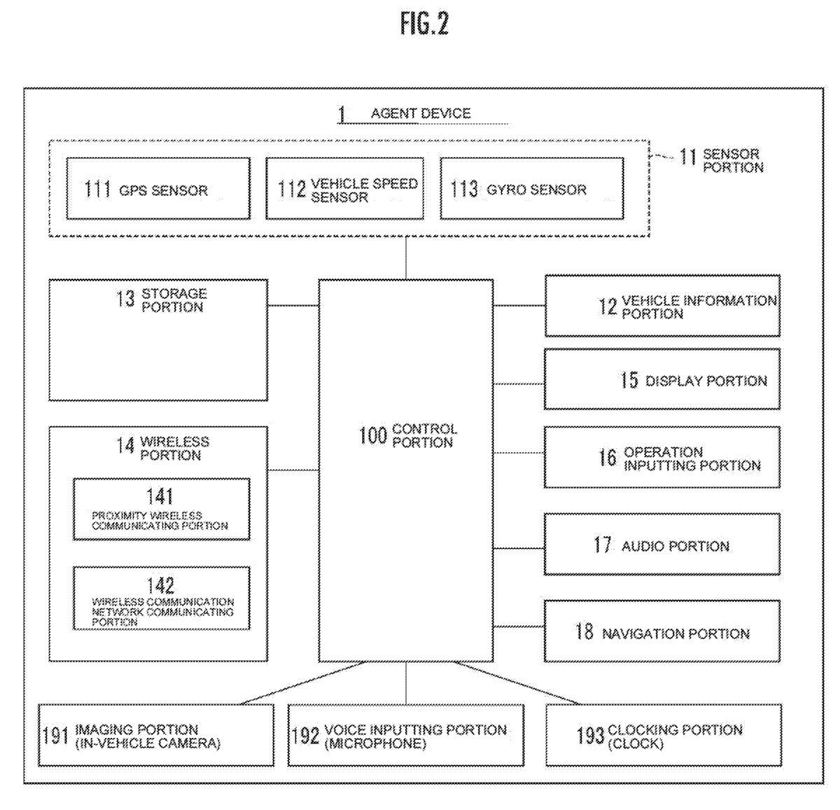

For example, as shown in FIG. 2, the agent device 1 has a control portion 100, a sensor portion 11 which has: a GPS sensor 111; a vehicle speed sensor 112; and a gyro sensor 113; and furthermore which may include an in-vehicle and outside-vehicle temperature sensor; a temperature sensor for a seat or a temperature sensor for a steering; and an acceleration sensor, a vehicle information portion 12, a storage portion 13, a wireless portion 14 which has a proximity wireless communicating portion 141 and a wireless communication network communicating portion 142, a display portion 15, an operation inputting portion 16, an audio portion 17 which means a voice outputting portion, a navigation portion 18, an imaging portion 191 which means an in-vehicle camera, an voice input portion 192 which means a microphone and a clocking portion 193 which means a clock. The clock may use the time information of the below-mentioned GPS: Global Positioning System.

The vehicle information portion 12 acquires the vehicle information through an in-vehicle network system including CAN: CAN-BUS and the like. For example, the vehicle information includes the information regarding ON/OFF of an ignition switch, operation conditions of safety device systems which are ADAS: Advanced Driving Assistant System, ABS: Antilock Brake System, and an airbag and the like.

The operation inputting portion 16 detects the inputs including control amount of a steering, an accelerator pedal or a brake pedal, and the manipulations of windows and manipulations of an air-conditioner which means the specified temperature value or the measured values of an in-vehicle and outside-vehicle temperature sensor, in addition to the manipulation of pressing down the switch and the like. These inputs are available to estimate the emotions of the passengers. The storage portion 13 of the agent device 1 has a sufficient memory capacity to continuously store the voice information of the passengers during driving the vehicle. Moreover, the server 3 may store various information.

The Configuration of the Portable Terminal Device

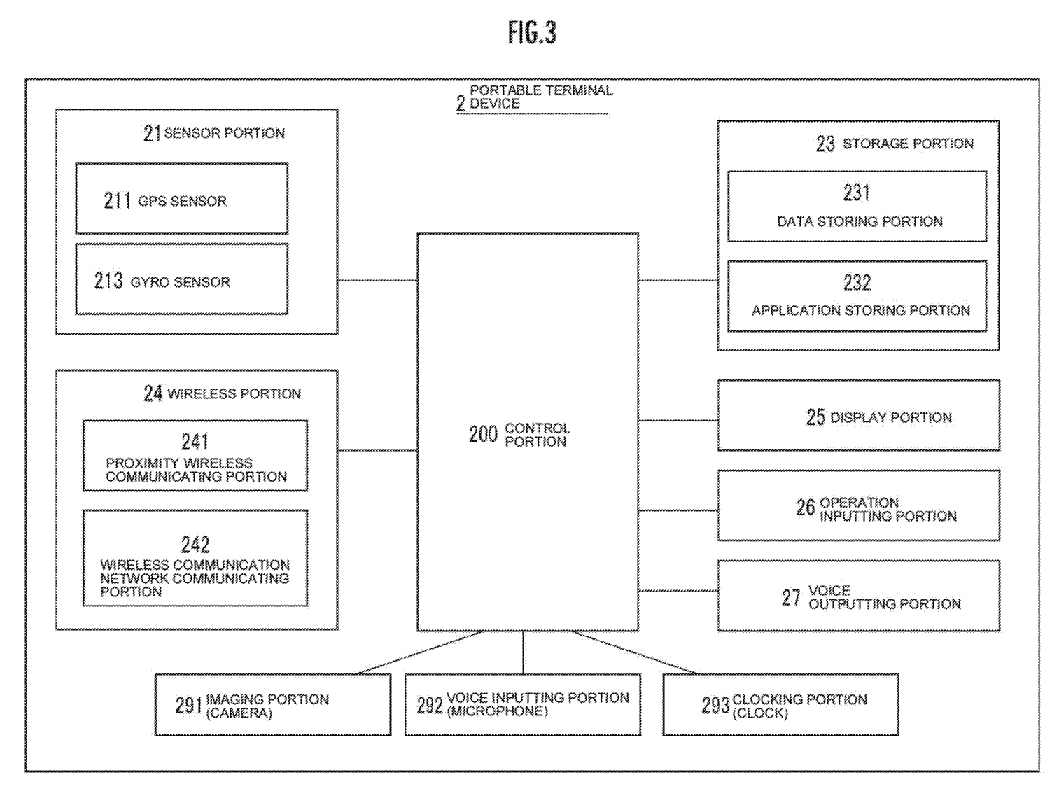

For example, as shown in FIG. 3, the portable terminal device 2 has: a control portions 200; a sensor portion 21 which includes a GPS sensor 211, a gyro sensor 213, and may also include a temperature sensor for measuring the temperature in the periphery of the terminal, and an acceleration sensor; a storage portion 23 which has a data storing portion 231 and an application storing portion 232; a wireless portion 24 which has a proximity wireless communicating portion 241 and a wireless communication network communicating portion 242; a display portion 25; an operation inputting portion 26; a voice outputting portion 27; an imaging portion 291 including a camera; a voice inputting portion 292 including a microphone; and a clocking portion 293 including a clock. The clock may use the time information of the below-mentioned GPS: Global Positioning System.

The portable terminal device 2 has components in common with the agent device 1. With reference to the vehicle information portion 12 in FIG. 2, the portable terminal device 2 does not have components acquiring the vehicle information. However, for example, the portable terminal device can acquire the vehicle information from the agent device 1 through the proximity wireless communicating portion 241. Moreover, following an application which means a software stored in the application storing portion 232, the portable terminal device 2 may have the same functions as those of the audio portion 17 and the navigation portion 18 of the agent device 1, respectively.

The Configuration of the Utterance Device

The utterance device 4 which is shown in FIG. 4 as one of the embodiment in the present disclosure is configured with one or both of the agent device 1 and the portable terminal device 2. The components of the agent device 1 consists of a part of the components of the utterance device 4. The components of the portable terminal device 2 consists of the other components of the utterance device 4. The agent device 1 and the portable terminal device 2 may cooperate with each other so as to mutually complement the respective components. For example, the utterance device may be configured such that the large information transmitted from the portable terminal device 2 to the agent device 1 can be stored by using the memory capacity of the agent device 1 which can be set comparably larger. Due to the fact that the functions including the application programs of the portable terminal device 2 and the like are rather frequently updated, or the passenger information can be easily acquired at any time on a daily basis, the utterance device may be configured such that the decision result and the information which are acquired at the portable terminal device 2 are transmitted to the agent device 1. The utterance device may be configured such that the agent device 1 directs the portable terminal device 2 to provide the information.

As for description of the numeral signs, N₁ (N₂) shows that it is configured with one or both of a component N₁ and a component N₂ or one or both of a component N₁ and a component N₂ are implemented.

The utterance device 4 includes the control portion 100 (200), and acquires the information and the stored information from the sensor portion 11 (21), the vehicle information portion 12, the wireless portion 14 (24), the operation inputting portion 16, the audio portion 17, the navigation portion 18, the imaging portion 191 (291), a voice inputting portion 192 (292), the clocking portion 193(293) including a clock, and the storing portion 13 (23) as well, as needed corresponding to each of their functions. Moreover, as necessary, the utterance device provides the information which means the contents from the display portion 15 (25) and the voice outputting portion 17 (27). Moreover, the storage portion 13 (23) stores the necessary information for the passenger optimization associated with the use of the utterance device 4. The utterance device 4 has an information acquiring portion 410, a passenger number grasping portion 450, an approach necessity determining portion 421, an approach acceptability estimating portion 422 which has a first passenger acceptability estimating portion 4221 and a second passenger acceptability estimating portion 4222, an approach content setting portion 423, an approach implementing portion 430, a history storing portion 441, a reaction storing portion 442. The control portion 100 (200) is, for example, implemented by one or more processors, or by hardware having equivalent functionality such as circuitry. The control portion 100 (200) may be configured by a combination of a processor such as a central processing unit (CPU), a storage device, and an ECU (electronic control unit) in which a communication interface is connected by an internal bus, or a micro-processing unit (MPU) or the like. Thus, he above-described portions in the utterance device 4 may be implemented by a processor which executes a program. Moreover, of these, some or all may be implemented by hardware such as a large scale integration (LSI) or an application specific integrated circuit (ASIC), or may be implemented by a combination of software and hardware.

The information acquiring portion 410 has a passenger information acquiring portion 411, an in-vehicle condition information acquiring portion 412, an audio operation condition information acquiring portion 413, a traffic condition information acquiring portion 414, and an external information acquiring portion 415. The passenger information acquiring portion 411 acquires the information regarding the passengers including the driver in the vehicle X as the passenger information, based on the output signals from the imaging portion 191 (291), the voice inputting portion 192 (292), the audio portion 17, the navigation portion 18, and the clocking portion 193 (293). The passenger information acquiring portion 411 acquires the information regarding the passengers including the passengers in the vehicle X as the in-vehicle condition information, based on the output signals from the imaging portion 191 (291), the voice inputting portion 192 (292) and the clocking portion 193 (293). The audio operation condition information acquiring portion 413 acquires the information regarding the operation condition of the audio portion 17 as the audio operation condition information. The traffic condition information acquiring portion 414 acquires the traffic condition information regarding the vehicle X by linking the server 2 with the navigation portion 18.

A passenger number grasping portion 450 grasps the number of passengers while distinguishing individuals based on the information acquired by the passenger information acquiring portion 411. The approach necessity determining portion 421 determines the necessity of the approaches to the passengers based on a “first information” which is at least one of the information among the passenger information, the in-vehicle condition information, and the traffic condition information, which are acquired by the information acquiring portion 410. The approach acceptability estimating portion 422 estimates that the acceptability of the passenger to the communication, based on “a second information” which is at least one of the information among the passenger information, the in-vehicle condition information, and the traffic condition information acquired by the information acquiring portion 410.

“The second information” may be same or different from “the first information”. The approach content setting portion 423 determines the content of the approaches to the passengers. The approach implementing portion 430 implements the approaches to the passengers according to the contents determined by the approach content setting portion 423. When the approach necessity determining portion 421 determines the necessity of the approaches, simultaneously, the approach acceptability estimating portion 422 estimates that the acceptability of the passenger for the interaction is larger than a threshold value. For example, the utterance through the voice outputting portion 17 (27) corresponds to the approaches.

The history storing portion 441 stores the contents of the approaches which are implemented to the passengers by the approach implementing portion 430. The approach content setting portion 423 determines the contents of the new approaches to the passengers based on the contents of the past approaches stored in the history storing portion 441. The reaction storing portion 442 stores the content of the approach which is implemented to the passengers by the approach implementing portion 430 in associated with the reaction information of the passenger which the information acquiring portion 410 acquires when the approach is implemented. A feedback information generating portion 440 generates the feedback information.

The Act of the Utterance Device

The act or function of the utterance device 4 which means the communication device with the above-mentioned configuration will be explained.

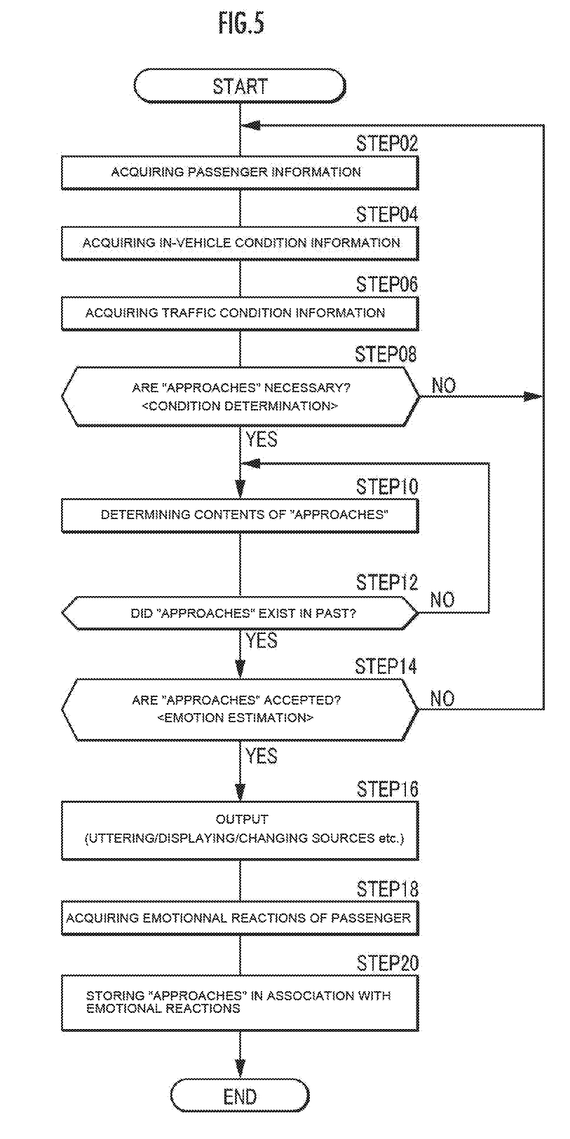

The passenger information acquiring portion 411 acquires the passenger information (FIG. 5/STEP02). The image video taken by the imaging portion 191 (291) showing the motions in which the passengers especially including the driver and the main passenger which means a first passenger in the vehicle X periodically moves parts of the body such as the head portion to the rhythm of the music output from the audio portion 17 and so on, may be acquired as the passenger information. A monologue which means a mutter, or a humming by the passenger detected by the voice inputting portion 192(292), may be acquired as the passenger information. The image video taken by the imaging portion 191 (291) showing the reactions including the eye movement of the passenger which means the first passenger, corresponding to the change of the image output or the voice output of the navigation portion 18, may be acquired as the passenger information. The information regarding the music content output from the audio portion 17 taken by the audio operation condition information acquiring portion 413, may be acquired as the passenger information.

The in-vehicle condition information acquiring portion 412 acquires the in-vehicle condition information (FIG. 5/STEP04). The image video taken by the imaging portion 191 (291) showing the motions in which the passengers, especially the fellow passengers, which means the auxiliary passenger or the second passenger of the driver in the vehicle X, close the eyes, looking the outside of the vehicle, and manipulating the smartphone, may be acquired as the in-vehicle condition information. The conversation between the first passenger and the second passenger, or the content of the utterance by the second passenger which are taken by the voice inputting portion 192 (292), may be acquired as the passenger information.

The traffic condition information acquiring portion 414 acquires the traffic condition information (FIG. 5/STEP06). The server 3 transmits the information as below to the utterance device 4. The information includes: a navigation route; the roads within the area including the navigation route; and the moving cost of links configuring the navigation route such as the distance, the required moving time, the degree of the traffic congestion, and the energy consumption, which may be acquired as the traffic condition information. The navigation route is configured with the plurality of links which continues from the present position or the starting position to the destination position, and is calculated by the navigation portion 18, or the navigation function of the portable terminal device 2, and the server 3. The GPS sensor 111 (211) measures the present position of the utterance device 4. The passenger sets the starting position and the destination position through the operation inputting portion 16 (26) and the voice inputting portion 192 (292).

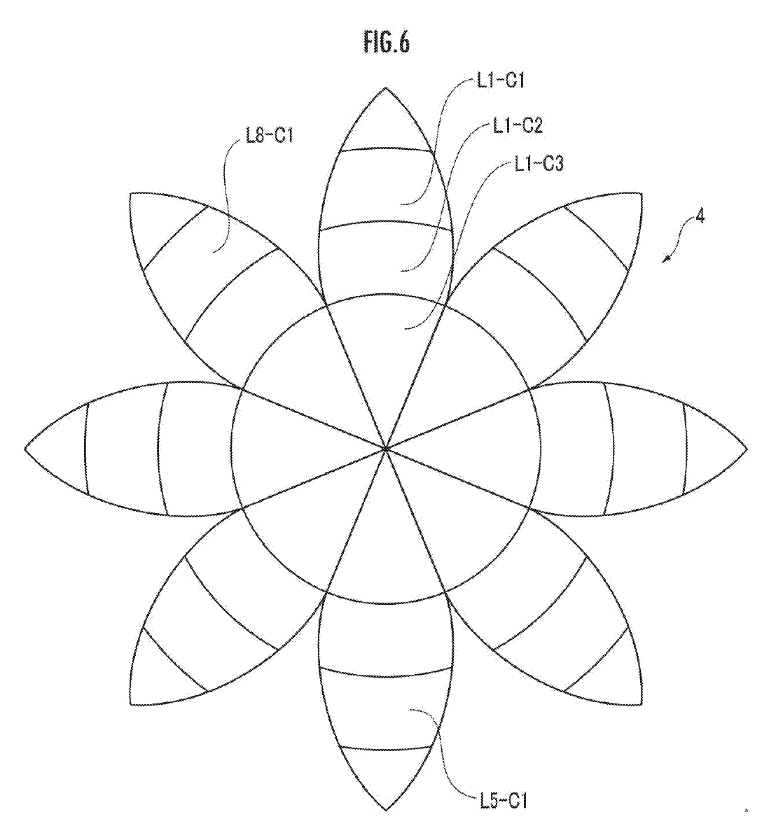

The approach necessity determining portion 421 determines the necessity of the approaches to the passenger based on “the first information” among the information acquired by the information acquiring portion 410 (FIG. 5/STEP08). Specifically, the emotion of the passenger is estimated with the first information as the input by using a filter created through machine learning including deep learning, support vector machine, and the like. The emotion estimation may be implemented based on known or new emotion models. FIG. 6 is a simplified diagram of the Plutchik model which is publicly known. The emotions are categorized into four classes and eight types. Joy, sadness, anger, disgust, terror, trust, surprise, anticipation are shown in the eight radiation directions L1 to L5, and to L8. When it approaches from C1 to C3 heading for the center of the circle, it is expressed that the degrees of the emotions become stronger.

For example, if the first information contains the image movie showing the state that the passenger is humming or nodding slightly back and forth to the music, it is estimated that the passenger has feelings including Like, Happy, or Comfortable. If the first information contains the traffic condition information showing the generation of the traffic congestion in the middle of the navigation route, it is estimated that the passenger has feelings including Dislike or Uncomfortable. Then, if it is estimated that the passenger has feelings including Dislike, Unenjoyable, or Boring, it is determined that the approaches are required.

If it is determined that the approaches are not required (FIG. 5/STEP08 •• NO), the passenger information, the in-vehicle condition information, and the traffic condition information are repeatedly acquired (FIG. 5/STEP02→STEP04→STEP06).

If it is determined that the approaches are required (FIG. 5/STEP08 •• YES), the approach content setting portion 423 determines the contents of the approaches (FIG. 5/STEP10). For example, the appropriate contents of the approaches are determined with the estimated emotion of the passenger as the input by using the filter created through machine learning including deep learning, support vector machine, and the like, in the light of the emotion.

For example, the contents of the approaches are determined corresponding to the Boring emotion of the passenger such that the utterance is output saying “The tune”, which means “How about changing the music content?”, or the output of the music contents are changed. The machine learning maybe implemented such that the contents of the approaches are determined so as to match the reaction information which is targeted by the reaction information of the passenger, based on the contents of the approaches and the reaction information regarding the passengers, which are stored in the reaction storing portion 442 in association with each other. If a conversation is set as the content of the approach, the conversation is implemented, which means displaying the profound knowledge, based on the information regarding special products, events, facilities information and the history in the currently traveling area. Then, the content setting portion excludes the topics which were spoken before.

The approach content setting portion 423 determines whether the approach implementing portion 430 implemented the approaches to the passenger, or not, with the same contents during a certain period in the past by inquiring the history storing portion 441 (FIG. 5/STEP12).

If it is determined that the approaches exists (FIG. 5/STEP12••NO), the content of the approach at this time is newly determined so as to be different from the content at the last time (FIG. 5/STEP10).

Meanwhile, if it is determined that the approaches does not exist (FIG. 5/STEP12••YES), the approach acceptability estimating portion 422 estimates whether the acceptability of the passenger for the approaches and the communication is larger than the threshold value or not, based on the second information among the information acquired by the information acquiring portion 410 (FIG. 5/STEP14). Specifically, the acceptability of the passenger is estimated with the second information as the input by using the filter created through machine learning including deep learning, support vector machine, and the like. With reference to FIG. 6, the emotion estimation may be implemented based on known emotion models or new emotion models.

For example, if the second information contains the image movie showing the state that the passenger is humming or nodding slightly back and forth to the music, it is estimated that the acceptability of the passenger to the communication which is an approach following the determined content, is less than the threshold value. If the second information contains the traffic condition information showing the generation of the traffic congestion in the middle of the navigation route, it is estimated that the acceptability of the passenger to the communication is less than the threshold value.

With reference to STEP02→STEP04→STEP06→STEP14 in FIG. 5, if the determined result is negative (FIG. 5/STEP14••NO), the acquisition and the determination process of the second information are repeated.

Meanwhile, if the determined result is positive (FIG. 5/STEP14••YES), the approach implementing portion 430 implements the approaches to the passenger following the contents determined by the passenger approach content setting portion 423 (FIG. 5/STEP16). Accordingly, the utterance saying “The tune”, which means “How about changing the music content?” may be output through the voice outputting portion 27, or the audio portion 17, and or the display portion 15 (25). Furthermore, if the reaction of the passenger to the utterance output is positive or is not negative, the music contents output from the audio function of the audio portion 17 or the portable terminal device 2 may be automatically changed.

Moreover, even in the case that the first passenger acceptability estimating portion 4221 estimates that one of the passengers is acceptable for the approaches including an utterance, if the second passenger acceptability estimating portion 4222 estimates that the other passengers are non-acceptable for the approaches, the approach content setting portion 423 configuring an utterance adjustment directing portion directs the approach implementing portion 430 to turn down the volume lower than the voice level at which the second passenger acceptability estimating portion 4222 estimates that the other passengers are acceptable for the approaches. Accordingly, for example, when the passenger takes a nap or is absorbed in other things, the utterance which means the voice output is shown in a whispering or murmuring style as if the device pays attention to the passengers.

If a plurality of voice outputting portions 17 (27) are disposed at different places in the vehicle X, respectively, the approach content setting portion 423 configuring the utterance adjustment directing portion may direct the approaches implementing portion 430 to adjust the vocal localization by selecting the voice outputting portions 17 (27) from which the voice is output. If the second passenger acceptability estimating portion 4222 estimates that the other passengers are non-acceptable for the approaches, the approach content setting portion 423 may direct the approaches implementing portion 430 to adjust the vocal localization so as to be positioned further away from the other passengers when the second passenger acceptability estimating portion 4222 estimates the other passengers are acceptable for the approaches.

The information acquiring portion 410 acquires the reaction information of the passengers to whom the approaches are implemented (FIG. 5/STEP18). Specifically, the emotions of the passengers are estimated and the estimation result is acquired as the reaction information with the first information and the second information as the inputs by using the filter created through machine learning including deep learning, support vector machine, and the like.

The approach implementing portion 430 let the history storing portion 441 store the contents of the approaches implemented to the passenger, and let the reaction storing portion 442 store the feedback information in associated with the contents of the approaches and the reaction information of the passenger (FIG. 5/STEP20).

According to the utterance device 4 in the present disclosure, the vehicle gains the functions to approach the passengers through conversation and the like so as to make the passengers sense the anthropomorphic behavior or the emotional expressions, which allows the passengers to stay somehow comfortable in the vehicle. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

1. An utterance device which at least utters to passengers in a vehicle, comprising:
a passenger information acquiring controller configured to acquire information of the passengers;
a passenger number grasping controller configured to grasp the number of the passengers while distinguishing individuals based on the information acquired by the passenger information acquiring controller;
an utterance acceptability estimating controller configured to estimate whether said passengers accept utterance from said utterance device; and
an utterance adjustment directing controller configured to direct adjustment of the utterance, wherein
when said utterance acceptability estimating controller estimates that one of said passengers accepts said utterance and another of the passengers does not accept the utterance, said utterance adjustment directing controller controls so as to turn down volume of the utterance to a voice level lower than a voice level in a case that said utterance acceptability estimating controller estimates that the another of the passengers also accepts the utterance.

2. The utterance device according to claim 1, wherein
said utterance adjustment directing controller adjusts a position of the utterance from which the utterance is output, and said utterance adjustment directing controller directs adjustment of the position of the utterance such that a distance between the position of the utterance and the another of the passengers when said utterance acceptability estimating controller estimates that the another of the passengers does not accept the utterance is larger than the distance when said utterance acceptability estimating controller estimates that the another of the passengers also accepts the utterance.

3. A communication device which implements approach including utterance to a passenger in a vehicle, comprising:
a passenger information acquiring controller configured to acquire information of the passenger during riding in the vehicle;
a condition information acquiring controller configured to acquire at least one of a vehicle information, a position information, and a traffic information as a condition information;
a content setting controller configured to set content of the approach to said passenger, based on said condition information;
an approach acceptability estimating controller configured to estimate whether said passenger accepts said approach, by using said passenger information, wherein
when it is estimated that said passenger accepts said approach, the communication device executes said approach, in addition to the utterance based on said passenger information.

4. The communication device according to claim 3,
the communication device includes a storage device which stores history of the executed approach associated with specific information regarding positioning, wherein
in the case that presenting specific information to the passenger is set as the content of the approach, said content setting controller acquires said specific information by using the position information of said vehicle and extracts said acquired specific information as a candidate, and determines whether said storage device has a history of presenting the specific information, and if so, the content setting controller excludes the extracted information from the candidate.

5. The communication device according claim 3,
wherein said vehicle includes a clocking portion and an audio device,
said vehicle information includes operation time information of said audio device,
said condition information includes timer information, and at least one of said approach acceptability estimating controller and said content setting controller controls the process by taking said operation time information into consideration.

6. A movable body comprising the utterance device according to Claim 1.

7. A movable body comprising the communication device according to claim 3.

8. The utterance device according to claim 2, wherein the utterance device includes a plurality of speakers respectively disposed at different positions from each other, and
said utterance adjustment directing controller changes the position of the utterance by changing the speaker.

9. A method of controlling an utterance device which at least utters to passengers in a vehicle, comprising:
(i) acquiring, using a computer, information of the passengers;
(ii) grasping, using the computer, the number of the passengers while distinguishing individuals based on the acquired information of the passengers
(iii) estimating, using the computer, whether said passengers accept utterance from said utterance device; and
(iv) adjusting, using the computer, the utterance by the utterance device, by:
when it is estimated by the step (ii) that one of said passengers accepts said utterance and another of the passengers does not accept the utterance, turning down volume of the utterance to a voice level lower than a voice level in a case that it is estimated that the another of the passengers also accepts the utterance.
